(19) United States
(12) Patent Application Publication
(10) Pub. No.: US 2013/0064150 A1
(43) Pub. Date: Mar. 14, 2013

(54) COMMUNICATION SYSTEM, TRANSMITTER, TRANSMISSION CONTROL METHOD, TRANSMISSION CONTROL PROGRAM, AND PROCESSOR

(71) Applicants: Kozue Hirata, Osaka-shi (JP); Shimpei Toh, Osaka-shi (JP); Takashi Onodera, Osaka-shi (JP); Hiroshi Nakano, Osaka-shi (JP); Hiromichi Tomeba, Osaka-shi (JP); Minoru Kubota, Osaka-shi (JP)

(72) Inventors: Kozue Hirata, Osaka-shi (JP); Shimpei Toh, Osaka-shi (JP); Takashi Onodera, Osaka-shi (JP); Hiroshi Nakano, Osaka-shi (JP); Hiromichi Tomeba, Osaka-shi (JP); Minoru Kubota, Osaka-shi (JP)

(73) Assignee: SHARP KABUSHIKI KAISHA, Osaka-shi, Osaka (JP)

(21) Appl. No.: 13/699,575

(22) PCT Filed: May 19, 2011
(86) PCT No.: PCT/JP2011/061535

§ 371 Date: Nov. 21, 2012

(30) Foreign Application Priority Data
May 31, 2010 (JP) 2010-125229

(51) Int. Cl. H04L 27/28

(52) U.S. Cl. 370/310

(57) ABSTRACT

A precoding deciding unit selects precoding for the spatial multiplexing of signals addressed to a plurality of receivers form a plurality of precodings. A filter multiplication unit multiplies the signals by filter coefficients to be used in the precoding selected by the precoding deciding unit.

### TECHNICAL FIELD

The present invention relates to a communication system, a transmitter, a transmission control method, a transmission control program, and a processor.

The subject application claims priority based on the patent application No. 2010-125229 filed in Japan on May 31, 2010 and incorporates by reference herein the content thereof.

### BACKGROUND ART

Recent years have seen progress in the standardization of fourth-generation mobile communication and various studies for the purpose of achieving an improvement in the downlink (communication from a base station to a terminal device) transmission rate. Although one solution that can be envisioned is the broadening of the system bandwidth, because bandwidth resources are limited, the solution of broadening the system bandwidth has its limitations. Given this, studies are undertaken regarding MIMO (multiple-input, multiple-output) technology as a useful technology, which enables spatial multiplexing of a plurality of signals at the same time and on the same frequency, without broadening the bandwidth. MIMO technology is spatial multiplexing transmission technology in which a plurality of antennas are provided for both transmitting and receiving, with transmission done of different signal streams from a plurality of transmitting antenna simultaneously.

In this downlink MIMO transmission, the MU-MIMO (multiple-user MIMO), which performs communication simultaneously between a base station having a plurality of antennas and a plurality of terminal devices, is gaining attention as a technique for improving the throughput. With MU-MIMO, because signals are simultaneously transmitted to a plurality of terminal devices from a base station, interference occurs in signals between the terminal devices. Given this, there is a known technology for applying precoding beforehand at the base station, so as to remove interference from signal addressed to other terminal devices.

An example of precoding has been proposed as a technique that uses ZF (zero forcing)-THP (Tomlinson-Harashima precoding), which employs QR decomposition. With this precoding, QR decomposition is used to calculate a unitary matrix Q that triangularizes the channel matrix, and the result of multiplying the unitary matrix Q by the inverse matrix of the diagonal elements of the triangularized matrix R is used as the transmission filter. In this technique, inter-user interference, which is expressed by the non-diagonal elements of the matrix R, is subtracted using THP. In this case, the interference signal is subtracted from the desired signal using THP, and a Modulo operation (remainder operation), which is non-linear processing, is applied, the Modulo operation resulting in the transmitted signal falling within a certain amplitude, enabling suppression of an increase in the transmitted signal power by the effect of interference subtraction processing.

Various proposals other than ZF-THP have been made regarding precoding (for example, Non-Patent Reference 1).

### PRIOR ART DOCUMENTS

### Non-Patent References

[Non-Patent Reference 1] M. Joham, J. Brehmer, and W. Utschick, “MMSE Approaches to multiuser spatio-temporal Tomlinson-Harashima precoding,” in Proc. 5th International ITG Conference on Source and Channel Coding, Erlangen, Germany, January 2004.

### SUMMARY OF THE INVENTION

### Problem to Be Solved by the Invention

With the precoding described in Non-Patent Reference 1, precoding is performed so that the receiving quality at each of a plurality of terminal devices that are disposed equidistantly from a base station is the same. Therefore, at a plurality of receivers, there will be a difference in receiving quality because of, for example, the distance from the transmitter. In this manner, conventional precoding has the drawback that it is not capable of flexibly controlling the receiving quality at a plurality of receivers.

The present invention has been made in consideration of the above-noted points, and provides a communication system, a transmitter, a transmission control method, a transmission control program, and a processor that enable flexible control of the receiving quality at a plurality of receivers.

### Means to Solve the Problem

(1) The present invention is made to solve the above-described problem, and a present invention is a communication system comprising a plurality of receivers and a transmitters spatially multiplexing and transmitting signals addressed to the plurality of receivers wherein the transmitter selects a precoding for spatial multiplexing of signals addressed to the plurality of receivers from a plurality of precodings, and transmits signals spatially multiplexed by the selected precoding.

(2) In the above communication system of the present invention, at least one of the plurality of precodings is performed based on a non-linear operation.

(3) In the above communication system of the present invention, the transmitter transmits a precoding information indicating the selected precoding to the receivers; and the receiver demodulates the signals transmitted by the transmitter, based on precoding information transmitted by the transmitter.

(4) In the above communication system of the present invention, the communication system according to any one of claim 1 to claim 3, wherein the transmitter selects from a plurality of precodings, based on information regarding the plurality of receivers.

(5) In the above communication system of the present invention, the transmitter performs a selection from the plurality of precodings, based on information regarding the receiving quality at the plurality of receivers.

(6) In the above communication system of the present invention, the transmitter performs a selection from the plurality of precodings, based on a difference between the receiving qualities at the plurality of receivers.

(7) In the above communication system of the present invention, the first precoding of the plurality of precodings is precoding in which each of the signals addressed to the plurality of receivers is multiplied by the same value or is not multiplied by a value; and the transmitter, selects the first encoding if the difference between the receiving qualities at the plurality of the receiver is smaller than a predetermined value.

(8) In the above communication system of the present invention, the second precoding of the plurality of precodings is precoding in which each of the signals addressed to the plurality of receivers is multiplied by different values; and the transmitter selects the second encoding if difference between the receiving qualities at the plurality of receivers is greater than a predetermined value.

(9) In the above communication system of the present invention, the transmitter performs the second encoding with respect to signals of the receiver having low receiving quality so as to be multiplied by large value.

(10) A present invention is a transmitter spatially multiplexing and transmitting signals addressed to a plurality of receivers; the transmitter comprising selecting a precoding for spatial multiplexing of signals addressed to the plurality of receivers from a plurality of precodings, and transmitting signals subjected to the selected precoding.

(11) A present invention is a method for controlling transmission in a transmitter spatially multiplexing and transmitting signals addressed to a plurality of receivers; the method for controlling transmission comprising a process of the transmitter selecting a precoding for spatial multiplexing of signals addressed to the plurality of receivers from a plurality of precodings, and transmitting signals subjected to the selected precoding.

(12) A present invention is a transmission control program for causing a computer of a transmitter that spatially multiplexes and transmits signals addressed to a plurality of receivers to implement a procedure of selecting precoding for spatial multiplexing of signals addressed to the plurality of receivers from a plurality of precodings, and transmitting signals subjected to the selected precoding.

(13) A present invention is a processor for selecting precoding for the spatial multiplexing of signals addressed to a plurality of receivers from a plurality of precodings.

### Effect of the Invention

According to the present invention, it is possible for a transmitter to flexibly control the receiving quality at a plurality of receivers.

### BRIEF DESCRIPTION OF THE DRAWINGS

FIG. 1 is a simplified drawing showing an example of a communication system according to a first embodiment of the present invention.

FIG. 2 is a simplified block diagram showing the constitution of a base station according to the present embodiment.

FIG. 3 is a simplified block diagram showing the constitution of a terminal device according to the present embodiment.

FIG. 4 is simplified drawing showing an example of a communication system according to a second embodiment of the present invention.

FIG. 5 is a simplified block diagram showing the constitution of a base station according to the present embodiment.

FIG. 6 is a simplified block diagram showing the constitution of a first precoding unit according to the present embodiment.

FIG. 7 is a simplified block diagram showing the constitution of a second precoding unit according to the present embodiment.

FIG. 8 is a simplified block diagram showing the constitution of a terminal device according to the present embodiment.

### EMBODIMENTS

### First Embodiment

A first embodiment of the present invention will be described in detail below, with references made to the drawings.

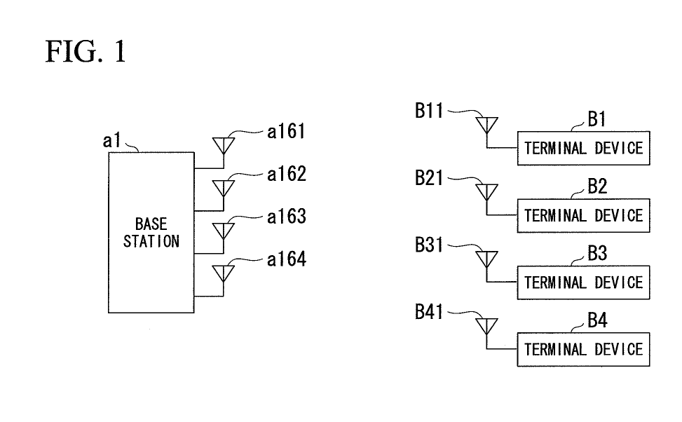

FIG. 1 is a simplified drawing that shows an example of a communication system according to the first embodiment of the present invention. In this drawing, the communication system has a base station a1 and a plurality of terminal devices B1 to BN. Although in FIG. 1, N=4, and in the present embodiment, N=4, this is not a restriction, and the conditions 1<N<4 or N>4 may also be adopted.

The base station a1 has the K transmitting antennas a161 to a16K. Although in FIG. 1, K=4 and, in the present embodiment, K=4, this is not a restriction, and the conditions K<4 or K>4 may also be adopted. The base station a1 spatially multiplexes and transmits signals addressed to the four terminal devices B1 to B4 at the same time and on the same frequency. The terminal devices Bn (where n=1 to N; each of the terminal devices Bn being referred to also as the terminal device b1) have one receiving antenna Bn1, and receive a signal transmitted from the base station a1. That is, in the communication system of FIG. 1, MU-MIMO transmission is performed. In this case, because each of the terminal devices B1 to BN is at a different distance from the base station a1, the receiving qualities of the signal transmitted by the base station a1 are different.

With MU-MIMO transmission, interference occurs between the signals to the terminal devices B1 to BN. The base station a1 performs precoding of a signal addressed to a given terminal device beforehand, so as to remove the interference from signals addressed to other terminal devices. In this case, the base station a1 selects and uses one precoding from among a plurality of precodings. The term precoding as used herein is the applying some type of processing to a signal that is intended to be transmitted, so as to convert a plurality of transmitted signals into signals capable of being spatially multiplexed.

<Base Station a1>

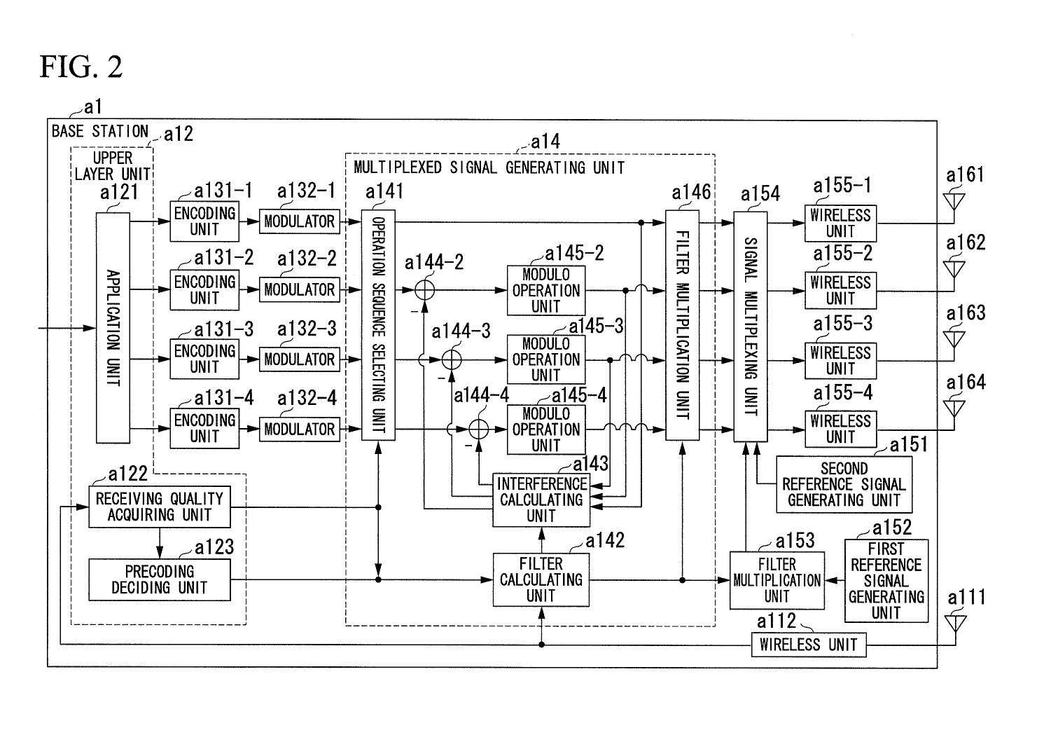

FIG. 2 is a simplified block diagram that shows the constitution of the base station a1 according to the present embodiment. In this drawing, the base station a1 is configured to include a receiving antenna a111, a wireless unit a112, an upper layer unit a12, encoding units a131-1 to a131-N, modulators a132-1 to a132-N, a multiplexed signal generating unit a14, a second reference signal generating unit a151, a first reference signal generating unit a152, a filter multiplication unit a153, a signal multiplexing unit a154, wireless units a155-1 to a155-K, and transmitting antennas a161 to a16K. The upper layer unit a12 is configured to include an application unit a121, a receiving quality acquiring unit a122, and a precoding deciding unit a123. The multiplexed signal generating unit a14 is configured to include an operation sequence selecting unit a141, a filter calculating unit a142, an interference calculating unit a143, subtractors a144-2 to a144-N, Modulo operation units a145-2 to a145-N, and a filter multiplication unit a146.

The base station a1 receives, using the receiving antenna a111, signals that are transmitted by the terminal devices B1 to BN. The signals received by the receiving antenna a111 are input to the wireless unit a112.

The wireless unit a112 down-converts the input signals to generate a baseband signal, and performs an A/D (analog-to-digital) conversion thereof. The wireless unit a112 demodulates the A/D-converted signal and outputs the demodulated information to the upper layer unit a12. In this case, the wireless unit a112, of the demodulated information, outputs receiving quality information for each of the terminal devices Bn (CQI; channel quality information) to the receiving quality acquiring unit a122 and outputs channel information (CSI: channel state information) to the filter multiplication unit a142. The receiving quality information of each of the terminal devices Bn is information that indicates the receiving quality of the signals from the base station a1 at each of the terminal devices and is, for example, dependent upon the distance from the base station a1 to each of the terminal devices Bn, the existence or non-existence of obstacles between the base station and the terminal, and whether a terminal is positioned indoors or outdoors. Specifically, if the receiving quality information is expressed as the receiving SNR (signal-to-noise ratio) at each of the terminal devices Bn, because a signal is received with a high SNR at terminal devices Bn that is positioned in proximity to the base station a1, the receiving quality information that indicates the receiving quality also has a high value. Conversely, at terminal devices Bn that are positioned at locations distant from the base station a1, the receiving quality information that indicates the receiving quality has a low value.

The base station a1, based on the receiving quality information and channel information for each of the terminal devices Bn, determines the encoding rate of information addressed to each of the terminal devices Bn (which is also addressed to the receiving antennas Bn1) and the modulation schemes. The base station a1 transmits to each of the terminal devices Bn the determined encoding rates of information addressed to each of the terminal devices Bn and control information indicating modulation schemes.

Information addressed to each of the terminal devices Bn, for example, is input to the application unit a121 of the upper layer unit a12 via a network. The application unit a121 outputs the information addressed to the terminal devices B1 to BN to the respective encoding units a131-1 to a131-N.

The receiving quality acquiring unit a122 outputs the receiving quality information input from the wireless unit a112 to the precoding deciding unit a123, the operation sequence selecting unit a141, and the filter calculating unit a142.

The precoding deciding unit a123, based on the receiving quality information input from the receiving quality acquiring unit a122, decides on one precoding from among a plurality of precodings. Specifically, the precoding deciding unit a123 makes a judgment regarding whether or not the differences between each of the receiving qualities of the terminal devices Bn (that is, terminal devices B1 to B4) that multiplex signals are smaller than a predetermined threshold value (for example, a receiving SNR of 3 dB).

If the precoding deciding unit a123 judges that the differences in receiving quality are smaller than a threshold value, it decides on ZF-THP as the precoding. That is, if there is no great difference in the receiving quality between the terminal devices Bn and the receiving qualities are approximately the same, the precoding deciding unit a123 decides on ZF-THP as the precoding.

If, however, a judgment is made that the differences in receiving quality are the same as or greater than the threshold value, the precoding deciding unit a123 decides on QR-THP as the precoding. That is, if there is a large difference in the receiving quality between the terminal devices Bn, and there is a trend in the receiving qualities, the precoding deciding unit a123 decides on QR-THP as the precoding.

The precoding deciding unit a123 outputs precoding information indicating the decided precoding to the filter calculating unit a142.

The encoding units a131-n encode information that has been input from the application unit a121 and that has been addressed to the terminal devices Bn with encoding rates decided by the base station a1, which are the encoding rates for information addressed to the terminal devices Bn. The encoding units a131-n output the encoded information dₙ to the corresponding modulators a132-n.

The modulators a132n modulate the information dₙ input from the encoding units a131-n using the modulation schemes for information addressed to the terminal devices Bn decided by the base station a1. The modulation schemes include, for example, QPSK (quadrature phase-shift keying) and 16-QAM (quadrature amplitude modulation). The modulators a132-n output the modulated signals sₙ to the operation sequence selecting unit a141 of the multiplex signal generating unit a14.

The operation sequence selecting unit a141, based on the receiving quality information input from the receiving quality acquiring unit a122, selects the output destination of the signal sₙ input from the modulators a132-n. Specifically, the operation sequence selecting unit a141 makes the signal Sₙ addressed to the terminal device Bn having the m-th lowest receiving quality (m=1 to N−1) that is indicated by the receiving quality information as the signal sₘ. The operation sequence selecting unit a141 outputs the signal s₁ to the filter calculating unit a146 and the interference calculating unit a143, and outputs the signals sₘ, (m≧2) to the corresponding subtractors a114-m.

The operation sequence selecting unit a141 may have input of the precoding information from the precoding deciding unit a123, and may select the output destination based on the receiving quality information only for the case in which the input precoding information indicates QR-THP.

The filter calculating unit a142 generates the channel matrix H from the channel information input from the wireless unit a112. In this case, the m-row, k-column element Hₘₖ (k=1 to N) of the channel matrix H is the channel estimated value between the transmitting antenna a16k of the base station a1 and the receiving antenna Bm1 of the terminal device Bm. The filter calculating unit a142, based on the receiving quality information input from the receiving quality acquiring unit a122, arranges the elements Hₘₖ in m sequence.

The filter calculating unit a142 performs QR decomposition of the complex conjugate transposition (Hermitian conjugate) matrix H^{H} of the generated channel matrix H, and calculates the matrix R and the matrix Q. QR decomposition is the decomposition of a matrix into a unitary matrix Q and a upper triangular matrix R. The filter calculating unit a142 outputs information that indicates the calculated matrix R to the interference calculating unit a143.

If the precoding information input from the precoding deciding unit a123 indicates QR-THP, the filter calculating unit a142 outputs the calculated matrix Q as filter coefficients to the filter multiplication unit a146 and the filter multiplication unit a153. If, however, the precoding information input from the precoding deciding unit a123 indicates ZF-THP, the filter calculating unit a142 multiplies the calculated matrix Q by {diag(R^{H})}⁻¹ and outputs the resulting matrix as filter coefficients to the filter multiplication unit a146 and the filter multiplication unit a153. In this case, diag(X) expresses the matrix X in which all non-diagonal elements are made zero.

The interference calculating unit a143, using the matrix R indicated by the information input from the filter calculating unit a142, successively generates the interference signals fₘ from the other terminal devices with respect to the signal sₘ addressed to the terminal device Bm input from the operation sequence selecting unit a141. Specifically, the interference calculating units a143, using the matrix R, calculates the interference coefficient matrix C={diag(R^{H})}⁻¹R^{H}−I.

The interference calculation unit a 143 successively generates the vectors sₘ′ that has the signal S₁ input from the operation sequence selecting units a141 and the signals s₂′ to sₘ₋₁′ input from the Modulo operation units a145-2 to a145-(m−1) as elements. The interference calculating unit a143, by multiplying the interference coefficient matrix C by the vector sₘ′, generates the interference signal fₘ. That is, the interference calculation unit a143 generates the interference signal f₂ as the second element of the matrix that is the product of multiplying the interference coefficient matrix C by (s₁, 0, 0, 0)^{T}, generates the interference signal f₃ as the third element of the matrix that is the product of multiplying the interference coefficient matrix C by (s₁, s₂′, 0, 0)^{T}, and generates the interference signal f₄ as the fourth element of the matrix that is the product of multiplying the interference coefficient matrix C by (s₁, s₂′, s₃′, 0)^{T}.

Although the present embodiment is described for the case in which N=4, N may be a value other than 4.

The interference calculating unit a143 outputs the generated interference signals fₘ to the respective subtractors a144-m.

The signals sₘ from the operation sequence selecting units a141 and the interference signals fₘ from the interference calculating unit a143 are input to the subtractors a144-m. The subtractors a144-m subtract the interference signals fₘ from the signals sₘ. The subtractors a144-m output the signals sₘ-fₘ after the subtraction to the Modulo operation units a145-m.

The Modulo operation units a145-m perform a Modulo operation (non-linear operation) with respect to the signals sₘ-fₘ input from the subtractors a144-m, in accordance with the modulation scheme for each of the terminal devices Bm decided by the base station a1. The Modulo operation units a145-m output the signals sₘ′ after the Modulo operation to the interference calculating unit a143 and the filter multiplication unit a146.

The filter multiplication unit a146 generates a vector s_{N}′=(s₁, s₂′, . . . , s_{N}′)^{T} that has elements that are the signal S₁ input from the operation sequence selecting unit a141 and the signals sₘ′ input from the Modulo operation units a145-m. The filter multiplication unit a146 multiplies the filter coefficients indicated by the information input from the filter calculating unit a142 by the generated vector s_{N}′. The filter multiplication unit a146 outputs the signals of the elements of the vector after the multiplication to the signal multiplexing unit a154.

The second reference signal generating unit a151 generates a pilot signal (reference signal) that is transmitted from each of the transmitting antennas a16k, which is a known signal between the base station a1 and the terminal device b1 (the waveform of which is stored beforehand), and which is orthogonalized between the transmitting antennas a161 to a164, so that there is no interference between the pilot signals transmitted from the plurality of transmitting antennas. The pilot signal generated by the second reference signal generating units a151 is used at each of the terminal devices b1 for the purpose of estimating the channel information that is notified to the base station a1. The second reference signal generating unit a151 outputs the generated pilot signal to the signal multiplexing unit a154.

The first reference signal generating unit a152 generates a pilot signal, which is A known signal between the base station a1 and the terminal device b1 (the waveform of which is stored beforehand), and which is orthogonalized between the transmitting antennas a161 to a164, so that there is no interference between the pilot signals transmitted from the plurality of transmitting antennas. The pilot signal generated by the first reference signal generating unit a152 is used at each of the terminal devices b1 for the purpose of demodulating the desired signal of the spatially multiplexed signals. The first reference signal generating unit a152 outputs the generated pilot signal to the filter multiplication unit a153.

The filter multiplication unit a153 multiplies the filter coefficients indicated by the information input from the filter calculating unit a142 by the pilot signal input from the first reference signal generating unit a152. The filter multiplication unit a153 outputs the signals after the multiplication to the signal multiplexing unit a154.

The signal multiplexing unit a154 multiplexes the signals input from the filter multiplication unit a146, the second reference signal generating unit a151, and the filter multiplication unit a153. In this case, the pilot signal input from the second reference signal generating unit a151 is, for example, orthogonalized and multiplexed in the time domain with the signals input from the filter multiplication unit a153. The signal multiplexing unit a154 includes and places into a control information signal a Modulo operation information signal indicating that a Modulo operation has been performed in the bandwidth allocated to the terminal devices Bm (m≧2).

After performing multiplexing in this manner, the signal multiplexing unit a154 outputs to the wireless units a155-k the signals to be transmitted from the transmitting antennas a16k.

The wireless units a155-k perform D/A (digital-to-analog) conversion on the signals input from the signal multiplexing unit a154, up-convert the thus-converted signals to the wireless frequency band, and transmit the signals to the terminal devices Bn via the transmitting antennas a16k.

<Processing in the Multiplexed Signal Generating Unit a14>

By the above-noted constitution, the processing in the multiplexed signal generating unit a14 is the processing shown below. The filter calculating unit a142 generates the channel matrix H of the following Equation (1).

$$H = [ \begin{matrix}{H}_{11} & {H}_{12} & {H}_{13} & {H}_{14} \\ {H}_{21} & {H}_{22} & {H}_{23} & {H}_{24} \\ {H}_{31} & {H}_{32} & {H}_{33} & {H}_{34} \\ {H}_{41} & {H}_{42} & {H}_{43} & {H}_{44}\end{matrix} ] \qquad ( 1 )$$

The filter calculating unit a142 calculates the filter coefficients Q for the purpose of triangularization of the channel matrix H. Specifically, the filter calculating unit a142, as shown by the following Equation (2), performs QR decomposition of the complex conjugate transposed matrix H^{H} of the channel matrix H, thereby calculating the matrix R and the filter coefficients (matrix Q).

$${H}^{H} = QR = Q [ \begin{matrix}{R}_{11} & {R}_{12} & {R}_{13} & {R}_{14} \\ 0 & {R}_{22} & {R}_{23} & {R}_{24} \\ 0 & 0 & {R}_{33} & {R}_{34} \\ 0 & 0 & 0 & {R}_{44}\end{matrix} ] \qquad ( 2 )$$

As described above, the interference calculating unit a143 uses the matrix R to calculate the interference coefficient matrix C={diag(R^{H})}⁻¹R^{H}−I. The signals sₘ-fₘ after the subtraction that are output by the subtractors a144-m are expressed by the following Equation (3).

$$[ \begin{matrix}{s}_{1} \\ {s}_{2} - {f}_{2} \\ {s}_{3} - {f}_{3} \\ {s}_{4} - {f}_{4}\end{matrix} ] = {[ \begin{matrix}{R}_{11}^{*} & 0 & 0 & 0 \\ {R}_{12}^{*} & {R}_{22}^{*} & 0 & 0 \\ {R}_{13}^{*} & {R}_{23}^{*} & {R}_{33}^{*} & 0 \\ {R}_{14}^{*} & {R}_{24}^{*} & {R}_{34}^{*} & {R}_{44}^{*}\end{matrix} ]}^{- 1} [ \begin{matrix}{R}_{11}^{*} & 0 & 0 & 0 \\ 0 & {R}_{22}^{*} & 0 & 0 \\ 0 & 0 & {R}_{33}^{*} & 0 \\ 0 & 0 & 0 & {R}_{44}^{*}\end{matrix} ] [ \begin{matrix}{s}_{1} \\ {s}_{2} \\ {s}_{3} \\ {s}_{4}\end{matrix} ] \qquad ( 3 )$$

The Modulo operation units a145-m perform the Modulo operations expressed by the following Equation (4).

$$v = {mod}_{τ} ( u ) = u - ⌊ \frac{Re [ u ]}{τ} + \frac{1}{2} ⌋ τ - j ⌊ \frac{Im [ u ]}{τ} + \frac{1}{2} ⌋ τ \qquad ( 4 )$$

In the above, └\tilde{ω}┘ is a floor function operation.

In this case, Re[u] and Im[u] are, respectively, the real part and the imaginary part of the complex value u. The floor function operation is the expression of the smallest integer that is w or greater. The symbol j is an imaginary value unit such that j²=−1. The second and third terms in Equation (4) indicate that the magnitudes of the real and imaginary parts of u are integer multiples of τ, which is a constant that is determined by the modulation scheme applied to the signals sₘ. For example, with QPSK (quadrature phase-shift keying), τ=2√2, with 16QAM (quadrature amplitude modulation), τ=8/√10, and with 64QAM, τ=16√42.

By performing a Modulo operation, the base station a1 can restrict the amplitude of the transmitted signal so that the amplitude of the signal after interference subtraction is within a certain swing of amplitude, thereby suppressing an increase in the transmitted power.

A signal output by the Modulo operation units a145-m, for example, the signal s₂′, is expressed by the following Equation (5).

s₂′=mod_{τ}(s₂−R₂₂*⁻¹R₁₂*s₁) (5)

By multiplying the channel matrix H by the filter coefficients, the following Equation (6) is obtained.

$$HQ = {( QR )}^{H} Q = {R}^{H} {Q}^{H} Q = {R}^{H} = [ \begin{matrix}{R}_{11}^{*} & 0 & 0 & 0 \\ {R}_{12}^{*} & {R}_{22}^{*} & 0 & 0 \\ {R}_{13}^{*} & {R}_{23}^{*} & {R}_{33}^{*} & 0 \\ {R}_{14}^{*} & {R}_{24}^{*} & {R}_{34}^{*} & {R}_{44}^{*}\end{matrix} ] \qquad ( 6 )$$

Equation (6) represents the equivalent channel, including the filter coefficients, between the base station a1 and a terminal device b1. The processing of calculating the filter coefficients in the filter calculation unit a142 need not be QR decomposition. That is, the filter calculating unit a142 can calculate, as the filter coefficients, a matrix that is converted to a triangular matrix when that is multiplied by the channel matrix H.

The received signal yₘ at each of the terminal devices Bm, in response to the precoding decided by the precoding deciding unit a123, is as follows.

If the difference in receiving quality is judged to be greater than the threshold value, and QR-THP is decided as the precoding, the vector y=(y₁, y₂, y₃, y₄) that has the received signals yₘ as elements is expressed as the following Equation (7).

$$y = {HQs}_{N}^{′} = [ \begin{matrix}{R}_{11}^{*} & 0 & 0 & 0 \\ {R}_{12}^{*} & {R}_{22}^{*} & 0 & 0 \\ {R}_{13}^{*} & {R}_{23}^{*} & {R}_{33}^{*} & 0 \\ {R}_{14}^{*} & {R}_{24}^{*} & {R}_{34}^{*} & {R}_{44}^{*}\end{matrix} ] [ \begin{matrix}{s}_{1} \\ {s}_{2}^{′} \\ {s}_{3}^{′} \\ {s}_{4}^{′}\end{matrix} ] = [ \begin{matrix}{R}_{11}^{*} & 0 & 0 & 0 \\ 0 & {R}_{22}^{*} & 0 & 0 \\ 0 & 0 & {R}_{33}^{*} & 0 \\ 0 & 0 & 0 & {R}_{44}^{*}\end{matrix} ] [ \begin{matrix}{s}_{1} \\ {s}_{2} \\ {s}_{3} \\ {s}_{4}\end{matrix} ] \qquad ( 7 )$$

In this case, because of the nature of QR decomposition, R₄₄<R₃₃<R₂₂<R₁₁. As described earlier, the operation sequence selecting unit a141 re-arranges the signals Sₙ in the sequence of lowest receiving quality. By doing this, the base station a1 increases the amplitude of a signal sₘ addressed to a terminal device Bm having a small m value and a low receiving quality, and decreases the amplitude of a signal sₘ addressed to a terminal device Bm having a large m value and a high receiving quality. The received signals yₘ in Equation (7) indicate signals that are addressed to the terminal device and that have had interference removed therefrom.

If, however, the judgment is made that the difference in receiving quality is smaller than the threshold value and ZF-THP is decided as the precoding, the received signal vector y is expressed by the following Equation (8).

$$y = H {diag [ R ]}^{- 1} {Qs}_{N}^{′} = {diag [ R ]}^{- 1} [ \begin{matrix}{R}_{11}^{*} & 0 & 0 & 0 \\ 0 & {R}_{22}^{*} & 0 & 0 \\ 0 & 0 & {R}_{33}^{*} & 0 \\ 0 & 0 & 0 & {R}_{44}^{*}\end{matrix} ] [ \begin{matrix}{s}_{1} \\ {s}_{2} \\ {s}_{3} \\ {s}_{4}\end{matrix} ] = [ \begin{matrix}{R}_{11}^{*} & 0 & 0 & 0 \\ 0 & {R}_{22}^{*} & 0 & 0 \\ 0 & 0 & {R}_{33}^{*} & 0 \\ 0 & 0 & 0 & {R}_{44}^{*}\end{matrix} ] [ \begin{matrix}{s}_{1} \\ {s}_{2} \\ {s}_{3} \\ {s}_{4}\end{matrix} ] \qquad ( 8 )$$

Comparing Equation (7) with Equation (8), whereas in Equation (7) the signal sₘ is multiplied by Rₘₘ, in Equation (8), the signal sₘ is not multiplied by Rₘₘ. By doing this, the base station a1 can make the amplitudes of the signals sₘ addressed to the terminal devices Bm be approximately the same.

By the above, by using ZF-THP for the case in which the base station a1 spatially multiplexes signals addressed to a plurality of terminal devices that are at approximately the same distance from the base station, and using QR-THP for the case in which the base station a1 spatially multiplexes signals addressed to a plurality of terminal devices having greatly different distances from the base station, it is possible to make the amplitude of the signals yₘ received by the terminal devices Bm have approximately the same size, regardless of the differences in the receiving quality at the terminal devices Bm, enabling maintenance of approximately the same receiving quality at all of the terminal devices. That is, the base station a1 can flexibly control the receiving quality at a plurality of terminal devices.

<Terminal Device b1>

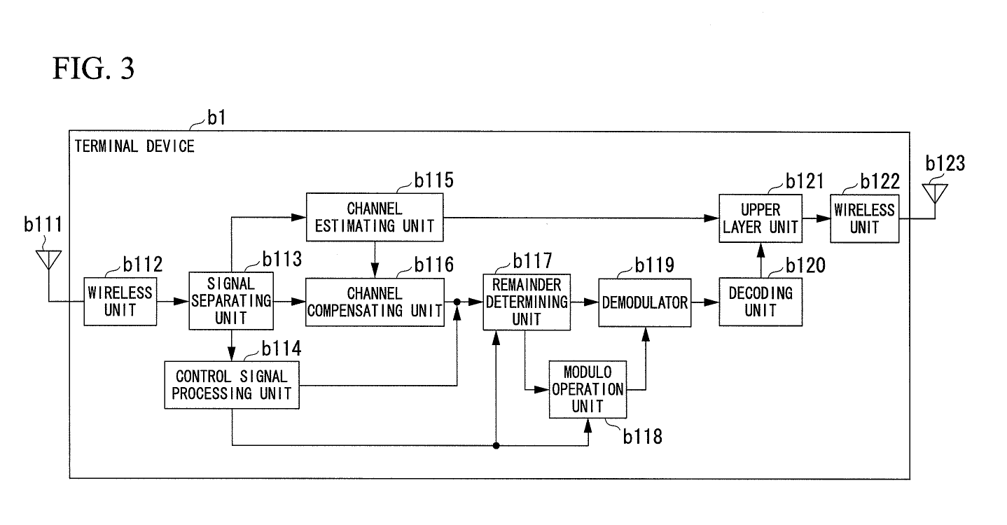

FIG. 3 is a simplified block diagram that shows the constitution of a terminal device B1 according to the present embodiment. In this drawing, the terminal device b1 is configured to include a receiving antenna b111 (Bn1), a wireless unit b112, a signal separating unit b113, a control signal processing unit b114, a channel estimating unit b115, a channel compensating unit b116, a remainder determining unit b117, a Modulo operation unit b118, a demodulator b119, a decoding unit b120, an upper layer unit b121, a wireless unit b122, and a transmitting antenna b123.

The wireless unit b112 receives a signal via the receiving antenna b111 (the signal received by the terminal device Bm being the received signal yₘ). This signal includes a pilot signal, a signal of information addressed to the terminal device Bm, and a signal of control information. The wireless unit b112 down-converts the received signal to a baseband signal, and then performs A/D (analog-to-digital) conversion of the baseband signal. The wireless unit b112 outputs the converted signal to the signal separating unit b113.

The signal separating unit b113 separates the signal input from the wireless unit b112, outputting the signal of control information to the control information receiving unit b113, and outputting the pilot signal to the channel estimating unit b115. Of the separated signals, the signal separating unit b113 outputs signals of information addressed to itself to the channel compensating unit b116.

The control signal processing unit b114 demodulates and decodes the control information signal input form the signal separating unit b113. Of the decoded control information, the control signal processing unit b114 outputs the remainder operation information and modulation scheme to the remainder determining unit b117 and the Modulo operation unit b118, respectively. Additionally, of the decoded control information, the control signal processing unit b114 outputs information regarding the encoding rate and modulation scheme to the demodulator b119 and decoding unit b120, respectively (not shown in figure).

The channel estimating unit b115, estimates the channel estimation values for each antenna, based on the pilot signal that has been generated by the second reference signal generating unit a151, among the pilot signal input from the signal separating unit b113. The channel estimating unit b115 uses this pilot signal to measurement the receiving quality. This measurement may be performed using a pilot signal that has been transmitted in a frame differing from that of the data signal. The channel estimating unit b115 outputs channel information indicating the estimated channel estimation value, and receiving quality information indicating the measured receiving quality to the upper layer unit b121.

The channel estimating unit b115, based on the pilot signal that has been generated by the first reference signal generating unit a152, among the pilot signal input from the signal separating unit b113, estimates the channel estimation value of the equivalent channel through which the signal addressed to the own device passes (the channel that includes the filter coefficients by which multiplication is done at the base station a1). The channel estimating unit b115 outputs to the channel compensating unit b116 equivalent channel estimation information that indicates the estimated value of the equivalent channel that has been estimated.

The channel compensating unit b116, by dividing the signal in accordance with the channel estimation value indicated by the equivalent channel estimation information input from the channel estimating unit b115, performs channel compensation. The channel compensating unit b116 outputs the channel-compensated signal to the remainder determining unit b117.

If remainder operation information is input from the control signal processing unit b114, the remainder determining unit b117 outputs the signal input from the channel compensating unit b116 to the Modulo operation unit b118. If, however, remainder operation information is not input form the control signal processing unit b114, the remainder determining unit b117 outputs the signal input from the channel compensating unit b116 to the demodulator b119. By this constitution, the remainder determining unit b117 of the terminal device B1 outputs the input signal to the demodulator b119, and the remainder determining units b117 of the terminal devices B2, B3, and B4 output the input signal to the Modulo operation unit b118.

The Modulo operation unit b118 performs a Modulo operation (the Modulo operation represented by Equation (4)), which is the same as the base station a1. In this case, the Modulo operation unit b118 selects τ that corresponds to the modulation scheme indicated by the information input from the control signal processing unit b114, and performs the Modulo operation using that τ. The Modulo operation unit b118 outputs the result of the operation to the demodulator b119.

The demodulator b119 demodulates the signal input from either the remainder determining unit b117 or the Modulo operation unit b118, using the modulation scheme indicated by the information input from the control signal processing unit b114. The demodulator b119 outputs the information demodulated from the signal to the decoding unit b120.

The decoding unit b120 decodes the information input from the demodulator b119, based on the encoding rate indicated by information input from the control signal processing unit b114. The demodulator b119 outputs the decoded information to the upper layer unit b121.

The upper layer unit b121 outputs the information input from the decoding unit b120 to an output unit (not shown in figure), or control the terminal device b1 based on the information. The upper layer unit b121 outputs the receiving quality information and the channel information input from the channel estimating unit b115 to the wireless unit b122 as the signal addressed to the base station a1.

The wireless unit b122 modulates the information input from the upper layer unit b121 and performs a D/A conversion on the modulated signal. The wireless unit b122 up-converts the modulated signal to the wireless frequency, and transmits the signal to the base station a1, via the transmitting antenna b123.

In this manner, in the present embodiment, the base station a1 selects precoding for spatial multiplexing of signals addressed to a plurality of terminal devices Bm from a plurality of precodings (ZF-THP and QR-THP), and transmits signals precoded with the selected precoding. By doing this, the communication system can select precoding from a plurality of precodings resulting in differing receiving qualities, enabling flexible control of the receiving quality at a plurality of terminal devices Bm.

In the present embodiment, ZF-THP is precoding in which each of the signals addressed to a plurality of terminal devices Bm is multiplied by the same value 1 (or is not multiplied by any value) (refer to Equation (8)). If the difference between the receiving qualities with addressing to a plurality of terminal devices Bm is smaller than a predetermined value, the base station a1 selects ZF-THP. By doing this, if the receiving quality at a plurality the terminal devices Bm is approximately the same, the terminal devices Bm can receive the signals as is so as to become approximately the same receiving quality.

In contrast, QR-THP is precoding in which each of the signals addressed to a plurality of terminal devices Bm is multiplied by different values (refer to Equation (3)). If the difference between the receiving qualities with addressing to a plurality of terminal devices Bm is the same as or greater than a predetermined value, the base station a1 selects QR-THP. By doing this, if the receiving quality at a plurality of terminal devices Bm differs greatly, the terminal devices Bm can receive the signals so that the receiving quality at each of the terminal device Bm is approximately the same.

Although the present embodiment is described for the case in which the precoding is selected based on receiving quality information of each terminal device Bn, the base station a1 may select the precoding based on the receiving quality information and on the amount of data in the information addressed to each of the terminal devices. For example, even if the base station a1 judges that the difference in receiving qualities is smaller than the threshold value, if the difference in the amount of data in the information addressed to each terminal device is at least a predetermined threshold value, the base station a1 may select QR-THP.

In this case, the base station a1 (operation sequence selecting unit a141) takes the signal Sₙ addressed to the terminal device Bn having the m-th largest amount of data as the signal sₘ. By doing this, the base station a1 can increase the receiving quality of a signal addressed to a terminal device Bm having a large amount of data, resulting in reliable transmission of the signal. Stated differently, the base station a1 can prevent the frequent occurrence of resending by occurrence of errors for cases of a large amount of data, thereby preventing a worsening of the transmission efficiency and an increase of the processing load.

Also, in this case, information addressed to a terminal device with a large amount of data may be modulated using a modulation scheme having a large number of modulation levels (for example, 16QAM), and information addressed to a terminal device with a small amount of data may be modulated using a modulation scheme having a small number of modulation levels (for example, QPSK).

Although the present embodiment is described for the case in which the base station a1 performs precoding by using QR decomposition, the present invention is not restricted in this manner, and precoding may be performed which generates filter coefficients based on the inverse matrix of the channel matrix, or precoding may be performed which calculates the filter coefficients within an MMSE limit, so that the mean square error between the transmitted signal and the received signals at each of the terminal devices is minimum.

### Second Embodiment

The second embodiment of the present invention will be described in detail below, with references made to the drawings.

This embodiment will be described for case in which a terminal device has a plurality of receiving antennas, and the base station transmits a plurality of signal streams to the terminal device.

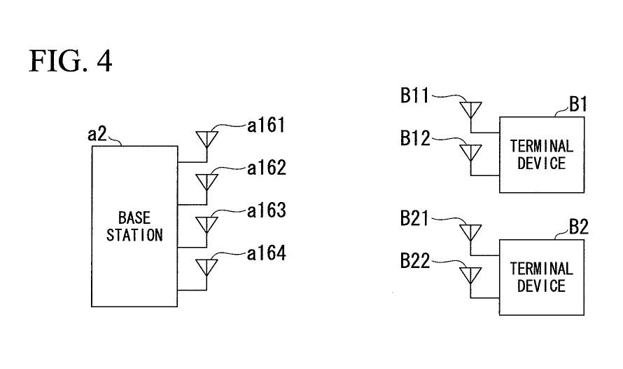

FIG. 4 is a simplified drawing that shows an example of a communication system according to the second embodiment of the present invention. In this drawing, the communication system has a base station a2 and a plurality of terminal devices B1 to BN. Although N=2 in FIG. 4 and N=2 in the present embodiment, the present invention is not restricted in this manner, and N may be larger than 2. The base station a2 has four transmitting antennas, a161 to a164.

The base station a2 spatially multiplexes and transmits a signal addressed to the two terminal devices B1 and B2 at the same time and using the same frequency. The terminal device Bn (where n=1 to N; each of the terminal devices Bn being referred to also as the terminal device b2) have Jₙ receiving antennas Bn1 to BnJₙ, and receive the signal transmitted from the base station a2. Although in FIG. 4 J₁, J₂=2, and in the present embodiment J₁, J₂=2, the present invention is not restricted in this manner, and the arrangements of J₁<2 and J₁>2 as well as J₂<2 and J₂>2 may also be adopted. Additionally, the condition J₁=J₂ need not be met.

In this case, because the terminal devices B1 to BN have different respective distances from the base station a2, the receiving quality of signals transmitted from the base station a2 are different.

With MU-MIMO transmission, interference occurs between the signals to the terminal devices B1 to BN. The base station a2 performs precoding and transmission of a signal addressed to a given terminal device beforehand, so as to remove the interference from signals addressed to other terminal devices. In this case, the base station a2 selects and uses one precoding from among a plurality of precodings.

Although the present embodiment is described for the case in which the terminal devices Bn have the same number of receiving antennas (two), the present invention is not restricted in this manner, and the number of receiving antennas of the terminal devices Bn may differ.

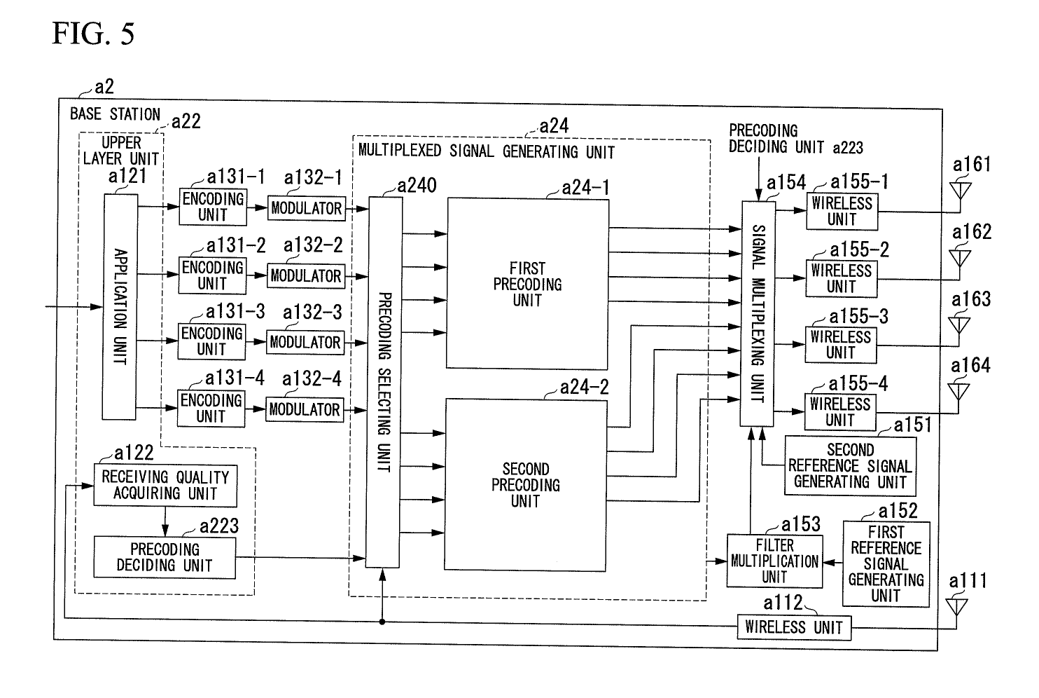

FIG. 5 is a simplified block diagram that shows the constitution of the base station a2 in the present embodiment. Comparing the base station a2 (FIG. 5) of the present embodiment with the base station a1 (FIG. 2) of the first embodiment, the precoding deciding unit a223 of the upper layer unit a22 and the multiplexed signal generating unit a24 are different. However, the functions of the other constituent elements (receiving antenna a111, wireless unit a112, application unit a121, receiving quality acquiring unit a122, encoding units a131-1 to a131-1 (where I=ΣJₙₒ, ΣJₙ is the total number of receiving antennas of the terminal devices, this being four in the present embodiment), modulators a132-1 to a132-1, second reference signal generating unit a151, first reference signal generating unit a152, filter multiplication unit a153, signal multiplexing unit a154, wireless units a155-1 to a155-4, and transmitting antennas a161 to a164) are the same as in the first embodiment. The descriptions of functions that are the same as in the first embodiment will be omitted.

The multiplexed signal generating unit a24 is configured to include a precoding selecting unit a240, a first precoding unit a24-1, and a second precoding unit a24-2.

If the judgment is made that the difference in receiving qualities is less than a threshold, the precoding deciding unit a223 decides on BD (block diagonalization) as the precoding. That is, if there is not a great difference in the receiving qualities between the terminal devices Bn and the receiving qualities are approximately the same, the precoding deciding unit a223 decides on BD as the precoding. If, however, the judgment is made that the differences in receiving qualities is at least the threshold value, the precoding deciding unit a223 decides on BT (block triangularization)-THP as the precoding. That is, if there is a great difference (for example, a receiving SNR of 5 dB) in the receiving qualities between the terminal devices Bn, the precoding deciding unit a223 decides on BT-THP as the precoding.

The precoding deciding unit a223 outputs precoding information that indicates the decided precoding to the precoding selecting unit a240. The precoding deciding unit a223 encodes and modulates the precoding information and outputs it to the signal multiplexing unit a154. The signals of the output precoding information are multiplexed by the signal multiplexing unit a154 and transmitted to each of the terminal devices b2.

The precoding selecting unit a240 inputs modulated signals Sᵢ from each of the modulators a132-i (i=1 to I), which are the signals Sᵢ addressed to the receiving antennas Bnj (j=1 to Jₙ) of the terminal devices Bn. In this case, i=j+Σ_{s≦n-1}Jₛ, the second term of which indicates taking the sum of the terminal devices Bs (where s≦n−1) for the total number Jₛ of receiving antennas.

If the precoding information input from the precoding deciding unit a223 indicates BD, the precoding selecting unit a240 outputs the input signal sᵢ and the receiving quality information to the first precoding unit a24-1.

If, however, the precoding information input from the precoding deciding unit a223 indicates BT-THP, the precoding selecting unit a240 outputs the input signal Sᵢ and the receiving quality information to the second precoding unit a24-2.

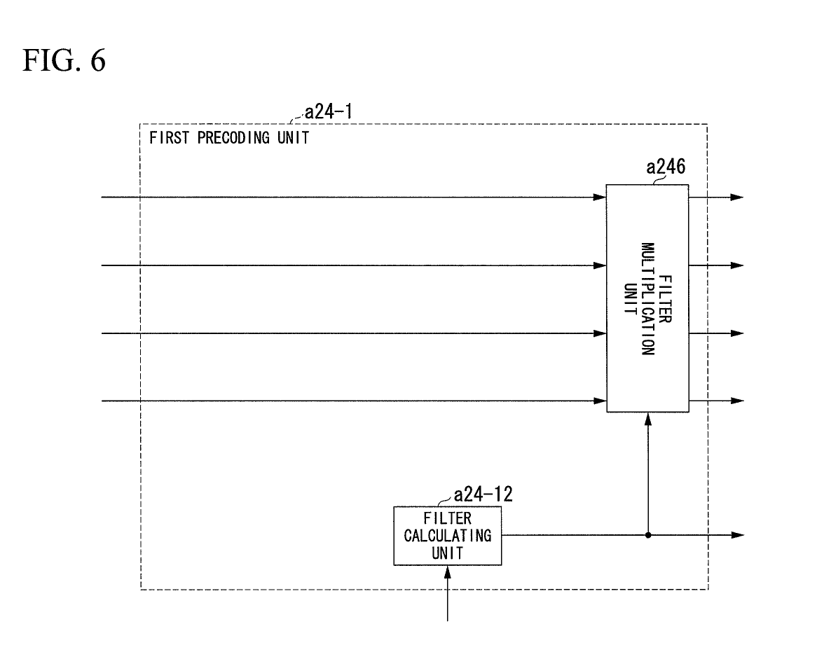

FIG. 6 is a simplified block diagram that shows the constitution of the first precoding unit a24-1 in the present embodiment. In this drawing, the first precoding unit a24-1 is configured to include a filter calculating unit a24-12 and a filter multiplication unit a246.

The filter calculating unit a24-12 generates a channel matrix H from the channel information input from the wireless unit a112. In this case, the n-th row, k-th column element H₁ₖ (k=1 to N) of the channel matrix H is the estimated channel value between the transmitting antenna a16k of the base station a2 and the receiving antenna Bnj of the terminal device Bn. If multiplication is to be done by the generated channel matrix H, the filter calculating unit a24-12 calculates the matrix M that is the block-diagonalized matrix of that matrix. In this case, block diagonalization refers to the case, when taking the matrix elements of each terminal device b2 as the elements (blocks), in which elements (non-diagonal blocks) other than diagonal elements (diagonal blocks) in the block are zero (refer to Equation (13)). The filter calculating unit a24-12 outputs the calculated matrix M as the filter coefficients to the filter multiplication unit a246 and the filter multiplication unit a153.

The filter multiplication unit a246 generates a vector sᵢ′=(s₁′, s₂′, . . . , s₁′)^{T} that has elements that are the signals Sᵢ (hereinafter referred to as the signals sᵢ′) input from the precoding selecting unit a240. The filter multiplication unit a246 multiplies the filter coefficients indicated by the information input from the filter calculating unit a142 by the generated vector sᵢ′. The filter multiplication unit a246 outputs the signals of the elements of the vector after multiplication to the signal multiplexing unit a154. The signal multiplexing unit a154 places the signals generated and output from the signals sᵢ′ in the frequency band to be transmitted from the transmitting antennas a16i.

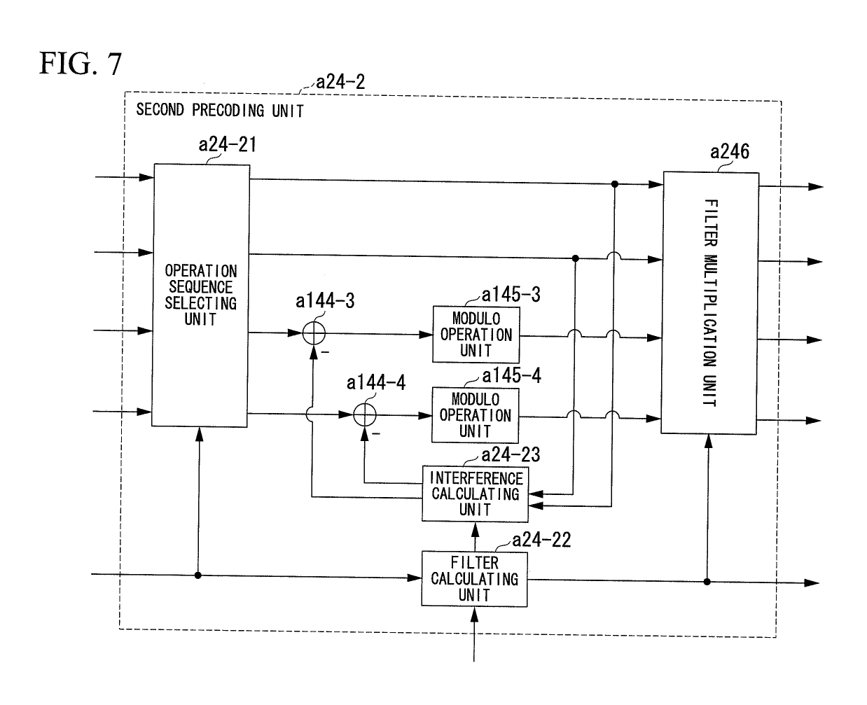

FIG. 7 is a simplified block diagram that shows the constitution of the second precoding unit a24-2 according to the present embodiment. In this drawing, the second precoding unit a24-2 is configured to include an operation sequence selecting unit a24-21, a filter calculating unit a24-22, an interference calculating unit a24-23, subtractors a144-3 (=J+1) to a144-4 (=I), Modulo operation units a145-3 to a145-4, and a filter multiplication unit a246.

In this case, because the functions of the subtractors a144-3 to a144-4 and the Modulo operation units a145-3 to a145-4 are the same as those in the first embodiment, the descriptions thereof will be omitted. Additionally, because the function of the filter multiplication unit a246 is the same as that in the first precoding unit (FIG. 6) except for different filter coefficients, the description thereof will be omitted.

The operation sequence selecting unit a24-21, based on the receiving quality information input from the receiving quality acquiring unit a122, selects the output destination for the signal Sᵢ input from the modulators a132-i. Specifically, the operation sequence selecting unit a24-21 makes the signal Sᵢ addressed to the J-th receiving antenna of the terminal device Bn having the m-th lowest receiving quality (m=1 to N−1) that is indicated by the receiving quality information as the signal sᵢ. The operation sequence selecting unit a141 outputs the signals s₁ and s₂ to the filter multiplication unit a246, and outputs the signals sᵢ (i≧3) to the corresponding subtractors a144-i.

The filter calculating unit a24-22 generates the channel matrix H from the channel information input from the wireless unit a112. If multiplication has been done by the generated channel matrix H, the filter calculating unit a24-22 calculates the matrix M that is that matrix block-triangularized towards the bottom. In this case, block triangularization refers to the case, when taking the matrix elements of each terminal device b2 as the elements (blocks), in which elements (non-diagonal blocks) to one side of the diagonal elements (diagonal blocks) are zero (refer to Equation (23)). The filter calculating unit a24-22 outputs the calculated matrix M as the filter coefficients to the filter multiplication unit a246 and the filter multiplication unit a153.

The filter calculating unit a24-22 outputs to the interference calculating unit a24-23 information indicating a matrix A that is the result of multiplying the channel matrix H by the matrix M.

The interference calculating unit a24-23, using the matrix A indicated by information input form the filter calculating unit a24-22, successively generates the interference signals fᵢ from the other terminal devices with respect to the signals Sᵢ (hereinafter referred to as the signals sᵢ) input from the precoding selecting unit a240. Specifically, the interference calculating unit a24-23, using the matrix A, calculates the interference coefficient matrix C={Diag(A)}⁻¹A−I. In this case, Diag(X) expresses the matrix in which non-diagonal blocks of matrix X are made zero.

The interference calculating unit a24-23 successively generates the vector sᵢ′ having elements that are the signals sᵢ input from the precoding selecting unit a240.

The interference calculating unit a24-23, by multiplying the interference coefficient matrix C by the vector sᵢ′, generates the interference signals fᵢ. That is, the interference calculating unit a142 generates the interference signal f₃ as the third element of the matrix that is the product of multiplying the interference coefficient matrix C by (s₁, s₂, 0, 0)^{T}, and generates the interference signal f₄ as the fourth element of the matrix that is the product of multiplying the interference coefficient matrix C by (s₁, s₂, 0, 0)^{T}.

Although in the example shown in FIG. 7 the interference calculating unit a24-23 generates only the vector s_{I}′ having elements that are the signal sᵢ, if there are N or more terminal devices, the signals s_{J1+1} to s_{1-JN} from the Modulo operation units a145-(J₁+1) to a145-(I−J_{N}) may be input thereto. In this case, J1 is the number of receiving antennas of the terminal device B1, and JN is the number of receiving antennas of the terminal device BN. In this case, the interference calculating unit a24-23 successively generates the signal sᵢ and the vector sᵢ′ having elements that are the signals s_{J1+1} to s_{1-JN}.

The interference calculating unit a24-23 outputs the generated interference signals fᵢ to the respective subtractors a144-i.

<Processing in the Multiplexed Signal Generating Unit a24>

By the above-noted constitution, the processing in the multiplexed signal generating unit a24 is the processing shown below. The filter calculating units a24-12 and a24-22 generate the channel matrix H of Equation (1). The row elements i of the channel matrix H are i=j+Σ_{s≦n-1}Jₛ.

The filter calculating units a24-12 and a24-22 extract the channel matrix H for each terminal device n (referred to as the propagation matrices Hₙ). Specifically, the filter calculating units a24-12 and a24-22 extract the following Equations (9) and (10).

$$\begin{matrix}{H}_{2}^{′} = {H}_{1} = [ \begin{matrix}{H}_{11} & {H}_{12} & {H}_{13} & {H}_{14} \\ {H}_{21} & {H}_{22} & {H}_{23} & {H}_{24}\end{matrix} ] & ( 9 ) \\ {H}_{1}^{′} = {H}_{2} = [ \begin{matrix}{H}_{31} & {H}_{32} & {H}_{33} & {H}_{34} \\ {H}_{41} & {H}_{42} & {H}_{43} & {H}_{44}\end{matrix} ] & ( 10 )\end{matrix}$$

In the case of BD, the filter calculating unit a24-12 performs singular value decomposition of the propagation matrices Hₙ. Specifically, the filter calculating unit a24-12 calculates the matrices Uₙ′, Dₙ′, and Vₙ′^{H} as expressed in the following Equation (11).

H′ₙ=U′ₙD′ₙV′ₙ^{H} (11)

In this case, the matrix Uₙ′ is a unitary matrix of Jₙ rows and Jₙ columns, the matrix Dₙ′ is a matrix of Jₙ rows and K columns in which the non-diagonal elements are zero and the diagonal elements are non-negative, and the matrix Vₙ′^{H} is unitary matrix of K rows and K columns. The decomposition of a matrix in this manner is called singular value decomposition. By using the matrix Vₙ′^{H}, it is possible in this communication system to make the signal addressed to the terminal device Bn not reach the other terminal devices.

The filter calculating unit a24-12 extracts a 4-row, 2-column matrix (which will be V_{n,2}), which is the right half (columns 3 and 4) of the matrix Vₙ′^{H}. The filter calculating unit a24-12, using this matrix V_{n,2}, calculates the matrix M′ given by the following Equation (12).

M′=[V_{1,2}V_{2,2}] (12)

At the base station the transmitted signal is precoded by Equation (12) and transmitted and, when it passes through the channel, as seen from the terminal device side, the channel is equivalent to the channel that is the matrix M′ multiplied by the channel matrix H, this being given by the following Equation (13).

$${HM}^{′} = [ \begin{matrix}{A}_{11} & {A}_{12} & 0 & 0 \\ {A}_{21} & {A}_{22} & 0 & 0 \\ 0 & 0 & {A}_{33} & {A}_{34} \\ 0 & 0 & {A}_{43} & {A}_{44}\end{matrix} ] = [ \begin{matrix}{H}_{1 , 1} & 0 \\ 0 & {H}_{2 , 2}\end{matrix} ] \qquad ( 13 )$$

In the above,

$$\begin{matrix}{H}_{1 , 1} = [ \begin{matrix}{A}_{11} & {A}_{12} \\ {A}_{21} & {A}_{22}\end{matrix} ] & ( 14 ) \\ {H}_{2 , 2} = [ \begin{matrix}{A}_{33} & {A}_{34} \\ {A}_{43} & {A}_{44}\end{matrix} ] & ( 15 )\end{matrix}$$

Equation (13) indicates that, if receiving is done via the channel of a signal which has been multiplied by the matrix M, interference is not received from signals addressed to the other terminal devices. That is, the channels indicated by Equation (13) are two SU-MIMO (single-user MIMO) channels. The filter calculating unit a24-12 performs singular value decomposition of H_{1,1} and H_{2,2} as shown by the following Equations (16) and (17), respectively.

H_{1,1}=U_{1,1}D₁V₁^{H} (16)

H_{2,2}=U_{2,2}D₂V₂^{H} (17)

In this case, the matrix U_{u,n} is a unitary matrix of 2 rows and 2 columns, and the matrix Dₙ is a matrix of 2 rows and 2 columns, having non-diagonal elements that are zero, and diagonal elements that are non-negative. The matrix Vₙ is a unitary matrix of two rows and two columns. The filter calculating unit a24-12 calculates the matrix M by the following Equation (18).

M=[V_{1,2}V₁V_{2,2}V₂] (18)

Ion the case of BD, the filter multiplication unit a246 multiplies the signal by the matrix M of Equation (18) as filter coefficients.

In the case of BT-THP, the filter calculating unit a24-22 performs singular value decomposition of the channel matrix H₁, as shown by Equation (19).

Although the present embodiment is described for the case of using Equation (18) as the filter coefficients, the present invention is not restricted in this manner, and the filter coefficients calculated by the filter calculating unit a24-12 may be filter coefficients so as to perform block diagonalization of the matrix after multiplication, when the channel matrix H is multiplied.

H₁=U₁D₁V₁^{H} (19)

In this case, the matrix V₁ is a unitary matrix of 4 rows and 4 columns. The filter calculating unit a24-22 extracts the matrix V₁ of the 4-row, 2-column matrix that is the left half (columns 1 and 2) of the matrix V₁ and of the a 4-row, 2-column matrix that is the left half (columns 3 and 4) of the matrix V₁, as the matrix V_{1,1} and the matrix V_{1,2}, respectively. The filter calculating unit a24-22, by performing a singular value decomposition of the matrix that is the matrix V_{1,2} multiplied by the matrix H₂, calculates the matrix V₂′. Specifically, the filter calculating unit a24-22 calculates the matrix V₂′ that satisfies the following Equations (20) and (21).

H₂′=H₂V_{1,2} (20)

H₂′=U₂′D₂′V₂′^{H} (21)

The filter calculating unit a24-22 calculates the matrix M by the following Equation (22).

M=[V_{1,1}V_{1,2}V₂′] (22)

In the case of BT-THP, the filter multiplication unit a246 multiplies the signal by the matrix M of Equation (22) as filter coefficients.

At the base station, the transmitted signal is precoded by Equation (22) and transmitted, and the signal received via the channel is the same as one that passes through a channel equivalent to a channel that is the matrix M of Equation (22) multiplied by the channel matrix H. This equivalent channel is given by the following Equation (23).

$$HM = [ \begin{matrix}{A}_{11} & {A}_{12} & 0 & 0 \\ {A}_{21} & {A}_{22} & 0 & 0 \\ {A}_{31} & {A}_{32} & {A}_{33} & {A}_{34} \\ {A}_{41} & {A}_{42} & {A}_{43} & {A}_{44}\end{matrix} ] \qquad ( 23 )$$

Equation (23) represents the equivalent channel between the base station a2 and the terminal device b2, including the filter coefficients. Equation (23) indicates that block triangularization is done. Although the present embodiment is described for the case in which Equation (23) is used as the filter coefficients, the present invention is not restricted in this manner, and the filter coefficients calculated by the filter calculating unit a24-22 may be filter coefficients so as to perform block triangularization of the matrix after multiplication, when the channel matrix H is multiplied.

The non-diagonal elements of Equation (23) indicate that a signal addressed to the terminal device B1 reaches the terminal device B2 and acts as an interference signal. The interference calculating unit a24-23 calculates this interference signal. Specifically, the interference calculating unit a24-23 calculates the interference signals f₃ and f₄, using the following Equation (24).

$$[ \begin{matrix}{f}_{3} \\ {f}_{4}\end{matrix} ] = {[ \begin{matrix}{A}_{33} & {A}_{34} \\ {A}_{43} & {A}_{44}\end{matrix} ]}^{- 1} [ \begin{matrix}{A}_{31} & {A}_{32} \\ {A}_{41} & {A}_{42}\end{matrix} ] [ \begin{matrix}{s}_{1} \\ {s}_{2}\end{matrix} ] \qquad ( 24 )$$

In this case, the relationship of the following Equation (25) is satisfied.

$$HM [ \begin{matrix}{s}_{1} \\ {s}_{2} \\ {s}_{3} - {f}_{3} \\ {s}_{4} - {f}_{4}\end{matrix} ] = [ \begin{matrix}{A}_{11} & {A}_{12} & 0 & 0 \\ {A}_{21} & {A}_{22} & 0 & 0 \\ {A}_{31} & {A}_{32} & {A}_{33} & {A}_{34} \\ {A}_{41} & {A}_{42} & {A}_{43} & {A}_{44}\end{matrix} ] [ \begin{matrix}{s}_{1} \\ {s}_{2} \\ {s}_{3} - {f}_{3} \\ {s}_{4} - {f}_{4}\end{matrix} ] = [ \begin{matrix}{A}_{11} & {A}_{12} & 0 & 0 \\ {A}_{21} & {A}_{22} & 0 & 0 \\ 0 & 0 & {A}_{33} & {A}_{34} \\ 0 & 0 & {A}_{43} & {A}_{44}\end{matrix} ] [ \begin{matrix}{s}_{1} \\ {s}_{2} \\ {s}_{3} \\ {s}_{4}\end{matrix} ] \qquad ( 25 )$$

The Modulo operation units a145-3 to a145-4 subtract the interference signals f₃ and f₄ calculated by the interference calculating unit a24-23 from the signals s₃ and s₄, respectively. By doing this, as shown by the right side of Equation (25), the vector sᵢ is multiplied by a block diagonalized matrix. That is, it is possible to achieve spatial multiplexing, so that signals addressed to a plurality of terminal devices do not mutually interference with one another.

<Terminal Device b2>

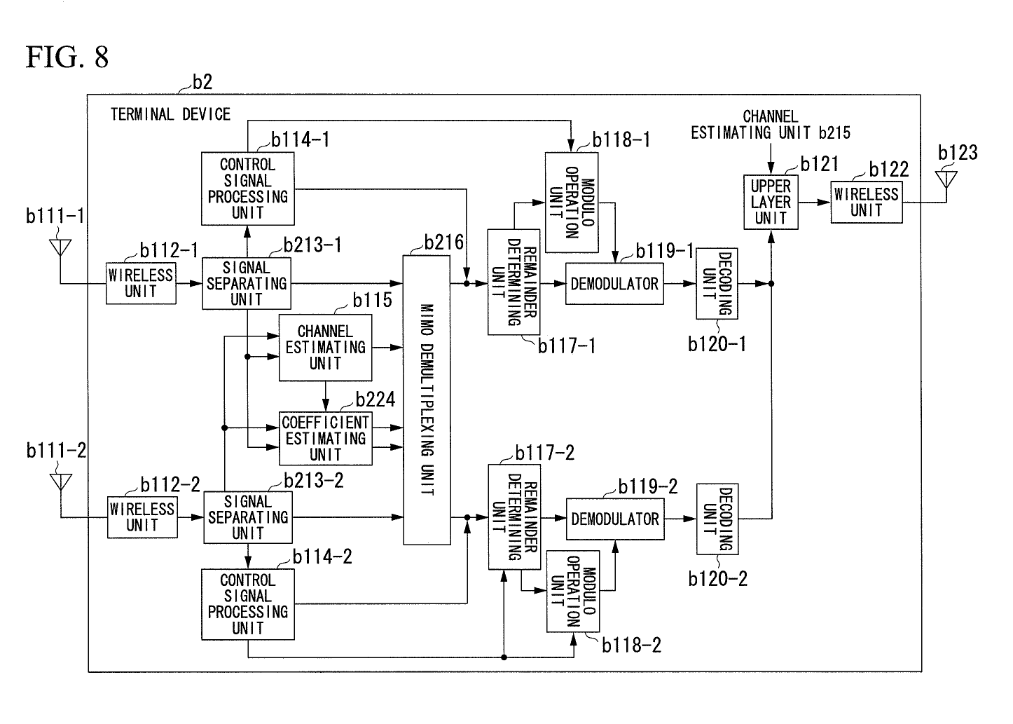

FIG. 8 is a simplified block diagram that shows the constitution of the terminal device b2 according to the present embodiment. In this drawing, the terminal device b2 is configured to include receiving antennas b111-1 (Bn1) and b111-2 (Bn2), wireless units b112-1 and b112-2, signal separating units b213-1 and b213-2, control signal processing units b114-1 and b114-2, a channel estimating unit b115, a coefficient estimating unit b224, a MIMO demultiplexing unit b216, remainder determining units b117-1 and b117-2, Modulo operation units b118-1 and b118-2, demodulators b119-1 and b119-2, decoding units b120-1 and b120-2, an upper layer unit b121, a wireless unit b122, and a transmitting antenna b123.

The functions of the receiving antennas b111-1 and b111-2 are the same as that of the receiving antennas b111, the function of the wireless units b112-1 and b112-2 are the same as that of the wireless unit b112, and the functions of the signal separating units b213-1 and b213-2 are the same as that of the signal separating unit b113. The functions of the control signal processing units b114-1 and b114-2 are the same as that of the control signal processing unit b114, and the functions of the remainder determining units b117-1 and b117-2 are the same as that of the remainder determining unit b117. The functions of the Modulo operation units b118-1 and b118-2 are the same as that of the Modulo operation unit b118, the functions of the demodulators b119-1 and b119-2 are the same as that of the demodulator b119, and the functions of the decoding units b120-1 and b120-2 are the same as that of the decoding unit b120. The functions of the channel estimating unit b115, the upper layer unit b121, and the wireless unit b122 are the same as those of the first embodiment. The description of these functions will be omitted.

A signal of precoding information and a pilot signal are input to the coefficient estimating unit b224 from the signal separating units b213-1 and b213-2. The coefficient estimating unit b224 demodulates and decodes a signal of the precoding information.

If the demodulated precoding information indicates BD, the coefficient estimating unit b224 calculates the filter coefficients of Equation (18) and outputs them to the MIMO demultiplexing unit b216. If, however, the demodulated precoding information indicates BT-THP, the coefficient estimating unit b224 calculates the filter coefficient of Equation (22) and outputs them to the MIMO demultiplexing unit b216. The coefficient estimating unit b224 outputs the precoding information to the MIMO demultiplexing unit b216.

The MIMO demultiplexing unit b216 of the terminal device Bn, based on channel information that is input from the channel estimating unit b115, generates the channel matrix Hₙ. The MIMO demultiplexing unit b216, based on the generated channel matrix Hₙ and on the filter coefficients input from the coefficient estimating unit b224, extracts a signal.

Specifically, if the precoding information input from the coefficient estimating unit b224 indicates BD, the MIMO demultiplexing unit b216 calculates the matrix U_{n,n} of Equations (16) and (17). If, however, the precoding information input from the coefficient estimating unit b224 indicates BT-THP, the MIMO demultiplexing unit b216 calculates the matrix U₁ of Equation (19) (for the case of the terminal device B1) or the matrix U₂′ of Equation (21) (for the case of the terminal device B2). The base station b2 may transmit information indicating whether each terminal device is the terminal device B1 or the terminal device B2 to each terminal device beforehand, and MIMO demultiplexing unit b216, based on this information, may calculate the matrix U₁ or U₂′.

The MIMO demultiplexing unit b216 multiplies the signal input from the signal separating units b213-1 and b213-2 by the calculated the matrix U_{n,n} and the matrix U₁ or the matrix U₂′. For example, at a terminal device B2 for the case in which the precoding information indicates BT-THP, because the matrix multiplying the matrix with which the product matrix HM is D₂′ (diagonal matrix), the MIMO demultplexing unit b216 extracts the signal by dividing by D₂′. As noted above, the MIMO demultiplexing unit b1216 extracts the signals of each stream. The MIMO demultiplexing unit b216 outputs the extracted signals to the remainder determining units b117-1 and b117-2 for each of the receiving antennas b111-1 and b111-2.

In this manner, in the present embodiment, the base station a1 selects precoding for the spatial multiplexing of signals addressed to a plurality of terminal devices Bn from a plurality of precodings (BD and BT-THP), and transmits signals that are precoded by the selected precoding. By doing this, the communication system can select precoding from a plurality of precodings having different receiving qualities, enabling flexible control of the receiving quality at the plurality of terminal devices Bn.

By providing a plurality of precoding means and selecting and using a precoding means from thereamong in a MU-MIMO system, it is possible to achieve MU-MIMO that exploits the characteristics of each of the precoding means, thereby enabling an improvement in the transmission characteristics. In particular, by selecting the precoding means in accordance with the combination of terminals that are to be spatially multiplexed, it is possible to select an appropriate precoding means in response to the conditions.

Although the present embodiment is described for the case in which the MIMO demultiplexing unit b216 calculates the matrix U_{n,n} and the matrix U₁ or the matrix U₂′, the present invention is not restricted in this manner. For example, the base station a2 may calculate these matrices, and transmit the calculated matrices to the terminal device b2. In this case, the MIMO demultiplexing unit b216 of the terminal device b2 extracts the signal using information regarding the received matrices. The MIMO demultiplexing unit b216 may extract the signal by other processing. For example, two received signals at each of the other terminal devices may be separated by MMSE (minimum mean square error) or MLD (maximum likelihood detection).

Also, although the present embodiment is described for the case in which the remainder determining units b117-1 and b117-2 select the output destination in response to the remainder operation information, the output destination may be selected in accordance with the precoding information and information indicating whether the terminal device is the terminal device B1 or the terminal device B2. For example, if the precoding information is BT-THP and also the terminal device is the terminal device B2, the remainder determining units b117-1 and b117-2 make output to the Modulo operation units b118-1 and b118-2, respectively, and in other cases, make output to the demodulators b119-1 and b119-2, respectively.

In the present embodiment, the processing in the filter calculating unit has been described for the case of two terminal devices. However, the present invention is not restricted in this manner, and there may two or more terminal devices. The following is a description of one example of the processing in the filter calculating unit in this case. The filter calculating unit a24-12 performs the following processing.

If the channel matrices for other than the n-th terminal device Bn are expressed by Hₙ(~) tilde, these can be expressed by the following equation.

\tilde{H}ₙ=[H₁^{T},H₂^{T}, . . . ,Hₙ₋₁^{T}Hₙ₊₁^{T}, . . . ,H_{N}^{T}]^{T} (26)

If Equation (26) is singular value decomposed, the following equation is obtained.

$$\begin{matrix}{\tilde{H}}_{n} = {\tilde{U}}_{n} {\tilde{D}}_{n} {\tilde{V}}_{n}^{H} \\ = {\tilde{U}}_{n} {{\tilde{D}}_{n} [ {\tilde{V}}_{n}^{′} {\hat{V}}_{n} ]}^{H}\end{matrix} \qquad ( 27 )$$

In Equation (27), the left singular value vector Uₙ~ is a unitary matrix on the terminal device side, Dₙ~ is a diagonal matrix (singular values), and the right singular value vector Vₙ~^{H} is a unitary matrix on the base station side. The Vₙ~^{H} is a K-row, K-column matrix. In this case, if the filter coefficients such that signals from other terminal device do not reach the n-th terminal device are defined as Vₙ^{̂}(hat), V Vₙ^{̂} is the matrix of Vₙ^{̂H} that is the extraction of the Jₙ column (number of receiving antennas of the n-th terminal device). Therefore, if the filter coefficients for block diagonalization in BD is M′, it is possible to express this by the following Equation (28).

M′=[\hat{V}₁,\hat{V}₂, . . . ,\hat{V}ₙ, . . . ,\hat{V}_{N}] (28)

In this case, at the base station a signal is precoded by the precoding of Equation (28) and transmitted and, when it passes through the channel, the channel, as seen from the terminal device side, is equivalent to the channel in which the channel matrix H is multiplied by the matrix M′. When this occurs, if the SU-MIMO channel at each of the terminal devices is HMₙ′, each thereof is singular value decomposed as shown in the following equation.

HMₙ′=UₙDₙVₙ^{H} (29)

The filter calculating unit a24-12 calculates the filter coefficients M by the following Equation (30).

M=[\hat{V}₁V₁,\hat{V}₂V₂, . . . ,\hat{V}ₙVₙ, . . . ,\hat{V}_{N}V_{N}] (30)

In contrast, the filter calculating unit a24-22 performs the following processing. If the filter coefficients for block triangularization in BT-THP is M′, this can be expressed as the following Equation (31).

M′=V_{N-1}′ . . . V₂′·V₁′ (31)

In the above, Vₙ′ is calculated as shown in the following Equation (32).

When n=N

$$\begin{matrix}\begin{matrix}{H}_{N} = H \\ = {[ \begin{matrix} & \\ \underbrace{{B}_{N - 1}^{T}}_{{\sum }_{k = 1}^{N - 1} {J}_{k}} , & \underbrace{{\tilde{B}}_{N - 1}^{T}}_{{\sum }_{k = 1}^{N - 1} {J}_{k}}\end{matrix} ]}^{T}\end{matrix} \\ {B}_{N - 1} = {U}_{N - 1}^{′} {D}_{N - 1}^{′} {V}_{N - 1}^{′ H} \\ When n \neq N \\ \begin{matrix}{H}_{N} = {H}_{n + 1} {V}_{n}^{′} \\ = {[ \begin{matrix} & \\ \underbrace{{B}_{n - 1}^{T}}_{{\sum }_{k = 1}^{n - 1} {J}_{k}} , & \underbrace{{\tilde{B}}_{n - 1}^{T}}_{{\sum }_{k = 1}^{n - 1} {J}_{k}}\end{matrix} ]}^{T}\end{matrix} \\ {B}_{n - 1} = {U}_{n - 1}^{′} {D}_{n - 1}^{′} {V}_{n - 1}^{′ H}\end{matrix} \} \qquad ( 32 )$$

In Equation (32), each of the Vₙ′ are successively calculated, in the n sequence of N, N−1, . . . , 2. In this case, of Hₙ, the channel matrix extracted for the purpose of block triangularization is defined as Bₙ^{T}, and the remaining channel matrix is defined as Bₙ~ (tilde). By singular value decomposition of this Bₙ, the Vₙ′ of Equation (31) is obtained.

In this case, at the base station a2, a transmitted signal is precoded by the precoding of Equation (31) and transmitted and, when it passes through the channel, the channel, as seen from the terminal device Bn side, is equivalent to the channel of the channel matrix H multiplied from right side by the matrix M′. When this occurs, HM′ is the block triangularized channel matrix. In this case, the channel matrix formed by each of the transmitting antennas and each of the terminal devices Bn is extracted. The extracted channel matrix is a single-user M IMO channel matrix of the base station a2 and each terminal device Bn disposed at diagonal elements, for example, in the example of Equation (25), a matrix in which elements other than A11, A12, A21, A22, A33, A34, A43 and A44 would be replaced by zero. If this matrix is A and the SU-MIMO channels at each of the terminal devices Bn is Aₙ′, the following Equation (33) is obtained.

$$A = [ \begin{matrix}{A}_{1} & 0 & 0 & 0 \\ 0 & {A}_{2} & 0 & 0 \\ 0 & 0 & ⋱ & 0 \\ 0 & 0 & 0 & {A}_{N}\end{matrix} ] \qquad ( 33 )$$

In this case, if Aₙ′ is singular value decomposed as shown in the following equation, the precoding matrix Vₙ with which the n-th terminal device Bn channel is multiplied is as shown by the following Equation (34).

Aₙ=UₙDₙVₙ^{H} (34)

The filter calculating unit a24-22 calculates the filter coefficients M by the following Equation (35).

$$M = [ \begin{matrix}{V}_{1} & 0 & 0 & 0 \\ 0 & {V}_{2} & 0 & 0 \\ 0 & 0 & ⋱ & 0 \\ 0 & 0 & 0 & {V}_{N}\end{matrix} ] \qquad ( 35 )$$

In the above-described embodiments, the base station a1 and a2 may receive from the terminal devices Bn receiving quality information in units of frames. In that case, however, the base station a1 may select the precoding for each individual frame, or at shorter or longer time intervals. In this case, for example, a combination of terminal device Bn identification information and information that indicates the precoding selected beforehand based on the receiving quality information are stored in the base stations a1 and a2. The base stations a1 and a2 select the precoding based on the stored information. After the elapse of a predetermined period of time, the base stations a1 and a2 repeat the selection of precoding based on the receiving quality information, and the storage of a combination of terminal device Bn identification information and information that indicates the selected precoding. The period of time used in the selection of precoding need not be predetermined, and may, for example, be decided on in response to the speed of movement of a terminal device Bn. Specifically, the time period may be made shorter, the faster is the speed of movement of the terminal device Bn, and may be made longer, the slower is the speed of movement of the terminal device Bn.

Also, in the above-described embodiments, the communication system may have a relay station that relays communication. For example, if the distance between the base stations a1 and a2 and the relay station is approximately the same, and it is possible to make a prior judgment that the difference in receiving qualities for each of the relay stations is smaller than the threshold value, the base stations a1 and a2 may decide on ZF-THP as the precoding when relaying with the relay station.

In the above-noted embodiments, the base stations a1 and a2 may use the ratio between receiving qualities in place of the difference between receiving qualities, and may make a judgment as to whether or not the ratio of receiving qualities is within 1±threshold value.

Although the above-noted embodiments the base stations a1 and a2 have used the maximum and minimum values of the receiving quality as the receiving quality difference, the present invention is not restricted in this manner, and the difference between the s-th (for example, second) highest threshold value and the t-th (for example, the third) lowest threshold value may be used.

The communication system according to the above-described embodiments may be a communication system that performs single-carrier transmission, and alternatively may be a communication system that performs multicarrier communication. The application to a multicarrier transmission can be achieved by calculating the filters or the like in units of subcarriers or groups of a number of subcarriers. In such cases, it becomes possible to orthogonalize the pilot signals in the frequency domain.

Additionally, the present invention can be applied to a system that performs communication in which a certain frequency band is divided into a number of subchannels, each subchannel being allocated to a plurality of terminal devices. For example, by allocating subchannel 1 to terminal devices 1 to 4, and subchannel 2 to terminal device 5 and 6, in such cases, by performing transmission for subchannels that are spatially multiplexed by the present invention, it is possible to perform efficient transmission addressed to a plurality of terminal devices, even in a system having a plurality of subchannels. In the case of using a plurality of subchannels in this manner, however, it is necessary to notify each of the terminal devices from the base station of information that identifies the subchannels allocated to each of the terminal devices, and each terminal device, based on the information which is notified from the base station, understands on which subchannels signals addressed to it are multiplexed and demodulates the signals addressed to it.

Alternatively, part of the base stations a1 and a2 and the transmitting devices b1 and b2 in the above-described embodiments, for example, the receiving quality acquiring unit a122, the precoding units a123 and a223, the operation sequence selecting unit a141, the filter calculating units a142, a24-12, and a24-22, the interference calculating unit a143, the subtractors a144-2 to a144-N, the Modulo operation units a145-2 to a145-N, the filter multiplication units a146 and a246, and the precoding selecting unit a240 may be implemented using a computer. In this case, a program for the purpose of implementing these control functions may be recorded on a computer-readable recording medium, and a computer system may read and execute the program recorded on the record medium. The term “computer system” means a computer system that is built into the base stations a1, a2 or into the terminal devices b1, b2, and includes an operating system and also hardware, such as peripheral devices. The term “computer-readable recording medium” refers to a portable medium, such as a flexible disk, an optical-magnetic disc, a ROM, and a CD-ROM, and a storage device, such as a hard disk that is built into a computer system. The term “computer-readable recording medium” may include something that dynamically retains a program for a short time, for example, a communication line when the program is transmitted via a network such as the Internet, a communication line such as a telephone line, or the like, as well as a medium to retain a program for a certain time, for example, a flash memory internally provided in a computer system acting as the server and client in that case. The program may have the object of implementing a part of the above-described functions, and it may also implement the above-described functions in combination with a program already stored in a computer system.

Alternatively, implementation of all or part of the base stations a1, a2 and of the terminal devices b1, b2 in the above-described embodiments may be done as an integrated circuit, such as an LSI (large-scale integration) device. Each of the functional blocks of the base stations a1, a2 and the terminal devices b1, b2 may be implemented as individual processors, or may be integrated by a part or all part thereof and implemented as a processor. The method of circuit integration may be not only by an LSI device but also by a dedicated communication circuit or by a general-purpose processor. In the case of the appearance of integrated circuit technology which take the place of LSI devices by advancements in semiconductor technology, it still possible to use an integrated circuit according to the present art.

Although the embodiments of the present invention are described above in detail with references made to the drawings, the specific configuration is not limited to the above-described embodiments, and various designs, changes and the like are encompassed within the scope thereof, without departing from the spirit of the present invention.

### INDUSTRIAL APPLICABILITY

Although the present invention is suitable for use as a mobile communication system, which is a wireless communication system using a mobile telephone as a mobile station, this is not a restriction.

[Description of Reference Numerals]

| | |
|---|---|
| a1, a2 | Base station |
| B1 to B4, b1, b2 | Terminal device |
| a111 | Receiving antenna |
| a112 | Wireless unit |
| a12, a22 | Upper layer unit |
| a131-1 to a131-N | Encoding unit |
| a132-1 to a132-N | Modulator |
| a14, a24 | Multiplexed signal generating unit |
| a151 | Second reference signal generating |
| | unit |
| a152 | First reference signal generating unit |
| a153 | Filter multiplication unit |
| a154 | Signal multiplexing unit |
| a155-1 to a155-K | Wireless unit |
| a161 to a16K | Transmitting antenna |
| a121 | Application unit |
| a122 | Receiving quality acquiring unit |
| a123, a223 | Precoding deciding unit |
| a141 | Operation sequence selecting unit |
| a142 | Filter calculating unit |
| a143 | Interference calculating unit |
| a144-2 to a144-N | Subtractor |
| a145-2 to a145-N | Modulo operation unit |
| a146, a246 | Filter multiplication unit |
| a240 | Precoding selecting unit |
| a24-1 | First precoding unit |
| a24-2 | Second precoding unit |
| B11 to B41, b111, b111-1, b111-2 | Receiving antenna |
| b112, b112-1, b112-2 | Wireless unit |
| b113, b213-1, b213-2 | Signal separating unit |
| a114, b114-1, b114-2 | Control signal processing unit |
| b115 | Channel estimating unit |
| b116 | Channel compensating unit |
| b117, b117-1, b117-2 | Remainder determining unit |
| b118, b118-1, b118-2 | Modulo operation unit |
| b119, b119-1, b119-2 | Demodulator |
| b120, b120-1, b120-2 | Decoding unit |
| b121 | Upper layer unit |
| b122 | Wireless unit |
| b123 | Transmitting antenna |
| b224 | Coefficient estimating unit |
| b216 | MIMO demultiplexing unit |

1. A communication system comprising:
a plurality of receivers; and
a transmitters spatially multiplexing and transmitting signals addressed to the plurality of receivers,
wherein the transmitter selects a precoding for spatial multiplexing of signals addressed to the plurality of receivers from a plurality of precodings, and transmits signals spatially multiplexed by the selected precoding.

2. The communication system according to claim 1, wherein at least one of the plurality of precodings is performed based on a non-linear operation.

3. The communication system according to claim 2, wherein:
the transmitter transmits a precoding information indicating the selected precoding to the receivers; and
the receiver demodulates the signals transmitted by the transmitter, based on precoding information transmitted by the transmitter.

4. The communication system according to claim 3, wherein the transmitter selects from a plurality of precodings, based on information regarding the plurality of receivers.

5. The communication system according to claim 4, wherein the transmitter performs a selection from the plurality of precodings, based on information regarding the receiving quality at the plurality of receivers.

6. The communication system according to claim 5, wherein the transmitter performs a selection from the plurality of precodings, based on a difference between the receiving qualities at the plurality of receivers.

7. The communication system according to claim 6, wherein:
the first precoding of the plurality of precodings is precoding in which each of the signals addressed to the plurality of receivers is multiplied by the same value or is not multiplied by any value; and
the transmitter, selects the first precoding if the difference between the receiving qualities at the plurality of the receiver is smaller than a predetermined value.

8. The communication system according to claim 6, wherein:
the second precoding of the plurality of precodings is precoding in which each of the signals addressed to the plurality of receivers is multiplied by different values; and
the transmitter selects the second precoding if difference between the receiving qualities at the plurality of receivers is greater than a predetermined value.

9. The communication system according to claim 8, wherein: the transmitter performs the second precoding with respect to signals of the receiver having low receiving quality so as to be multiplied by large value.

10. A transmitter spatially multiplexing and transmitting signals addressed to a plurality of receivers,
wherein the transmitter selects a precoding for spatial multiplexing of signals addressed to the plurality of receivers from a plurality of precodings; and
transmits signals subjected to the selected precoding.

11. A method for controlling transmission in a transmitter spatially multiplexing and transmitting signals addressed to a plurality of receivers; the method for controlling transmission comprising:
making the transmitter select a precoding for spatial multiplexing of signals addressed to the plurality of receivers from a plurality of precodings, and transmit signals subjected to the selected precoding.

12. A transmission control program for causing a computer of a transmitter that spatially multiplexes and transmits signals addressed to a plurality of receivers to implement a process of selecting a precoding for spatial multiplexing of signals addressed to the plurality of receivers from a plurality of precodings, and a process of transmitting signals subjected to the selected precoding.

13. A processor for selecting a precoding for spatial multiplexing of signals addressed to a plurality of receivers from a plurality of precodings.

14. The communication system according to claim 7, wherein:
the second precoding of the plurality of precodings is precoding in which each of the signals addressed to the plurality of receivers is multiplied by different values; and
the transmitter selects the second precoding if difference between the receiving qualities at the plurality of receivers is greater than a predetermined value.
